(19) United States
(12) Patent Application Publication
(10) Pub. No.: US 2017/0269719 A1
(43) Pub. Date: Sep. 21, 2017

(54) PRESSURE SENSITIVE STYLUS PEN

(71) Applicant: Primax Electronics Ltd., Taipei (TW)

(72) Inventors: CHENG-YI TSAI, Taipei (TW); YING-CHE TSENG, Taipei (TW); A-MING CHANG, Taipei (TW)

(21) Appl. No.: 15/149,514

(22) Filed: May 9, 2016

(30) Foreign Application Priority Data
Mar. 18, 2016 (TW) 105203821

(51) Int. Cl. G06F 3/0354; G06F 1/16

(52) U.S. Cl. CPC G06F 3/03545; G06F 1/169

(57) ABSTRACT

The present invention discloses a pressure sensitive stylus pen, including a housing, a substrate, an accommodation slot, a fastening base, and a pressure sensor. The substrate is disposed inside the housing, and the accommodation slot is disposed in the substrate. The fastening base is disposed in the accommodation slot, and the pressure sensor is disposed in the fastening base. The pressure sensor bears an external force and generates a sensing signal, and the pressure sensor is fastened in the fastening base; therefore, the pressure sensor can be firmly disposed inside the housing and does not fall off.

### FIELD OF THE INVENTION

The present invention relates to a stylus pen, and in particular, to a pressure sensitive stylus pen.

### BACKGROUND OF THE INVENTION

A pressure sensitive stylus pen refers to a stylus pen in which a pressure sensor is disposed When a user holds the pen to write or click, a touching rod in the stylus pen moves inwards and touches and presses the pressure sensor, so that the pressure sensor generates an electronic signal, and the electronic signal is then transferred to an electronic apparatus (for example, a touchpad or a tablet computer), to rapidly input an instruction and information to the electronic apparatus.

No particular positioning mechanism is set for a pressure sensor in a known pressure sensitive stylus pen; therefore, when the pressure sensitive stylus pen is frequently used for a long time, the pressure sensor in the pen easily displaces or falls off because of shaking, and as a result, pressure sensing is undesirable, and touch control is insensitive. In addition, a pressure sensor component is small. It is, therefore, relatively difficult to target an installation position inside the stylus pen during installation, and it is not easy to correctly and rapidly dispose the pressure sensor component, which increases installation difficulty. Therefore, many aspects in the prior art still need to be improved.

### SUMMARY OF THE INVENTION

To resolve problems in the prior art, the present invention provides a pressure sensitive stylus pen, in which a pressure sensor is disposed in a fastening base, and an accommodating space is disposed in a housing of the stylus pen, to accommodate the pressure sensor and the fastening base. In this way, the pressure sensor is fastened inside the stylus pen and does not easily fall off, and it is easy to correctly and rapidly install and replace the pressure sensor.

To achieve the foregoing objective, the pressure sensitive stylus pen in the present invention includes:

a housing;

a substrate, disposed inside the housing;

an accommodation slot, disposed in the substrate;

a fastening base, disposed in the accommodation slot;

a pressure sensor, disposed in the fastening base, where the pressure sensor is configured to generate a sensing signal;

a triggering pole, where a part of the triggering pole extends into the housing, and when the triggering pole is touched and pressed by an external force, the triggering pole touches and presses the pressure sensor, to trigger the pressure sensor to generate the sensing signal; and

a circuit board, electrically connected to the pressure sensor, where the circuit board receives the sensing signal to generate an electronic signal, the pressure sensor is fastened on the fastening base, and therefore, the pressure sensor is disposed inside the housing firmly.

Preferably, the pressure sensor includes a flat cable, used to connect the pressure sensor and the circuit board, to transmit the sensing signal to the circuit board.

Preferably, the accommodation slot includes an accommodating space, used to embed the fastening base into the accommodation slot, to fasten the fastening base in the substrate.

Preferably, the pressure sensor is adhered to a surface of the fastening base, so that the pressure sensor is fastened in the substrate.

Preferably, the triggering pole includes a touching end that is perpendicular to the surface of the fastening base and that is used to touch and press the pressure sensor.

Preferably, the fastening base includes a concave part, and the pressure sensor is disposed in the concave part.

Preferably, the pressure sensitive stylus pen further includes a housing cover and a stop block, the housing cover is connected to the housing, the stop block is disposed inside the housing cover and is located in the housing, a part of the triggering pole passes through the housing cover and extends into the housing, and the stop block surrounds the triggering pole.

Preferably, the pressure sensitive stylus pen further includes a spring that surrounds the triggering pole.

Preferably, the accommodation slot is integrally formed in the substrate.

### BRIEF DESCRIPTION OF THE DRAWINGS

FIG. 1 is a three-dimensional view according to a preferred embodiment of the present invention;

FIG. 2 is a three-dimensional exploded view according to a preferred embodiment of the present invention;

FIG. 3 is a three-dimensional exploded view of a substrate according to a preferred embodiment of the present invention;

FIG. 4 is a three-dimensional exploded view of a substrate according to a preferred embodiment of the present invention;

FIG. 5 is a schematic diagram of a status in which a stylus pen is not touched and pressed according to a preferred embodiment of the present invention; and

FIG. 6 is a schematic diagram of a status in which a stylus pen is touched and pressed according to a preferred embodiment of the present invention.

### DETAILED DESCRIPTION OF THE PREFERRED EMBODIMENT

The following describes preferred embodiments of the present invention with reference to diagrams.

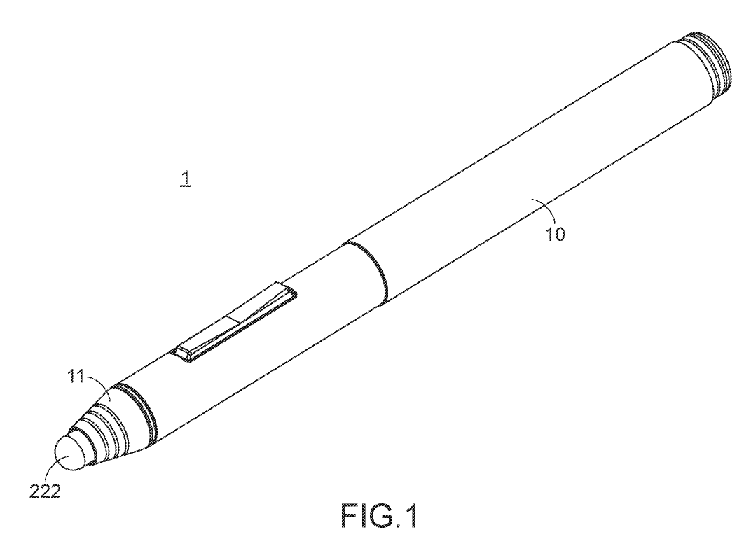

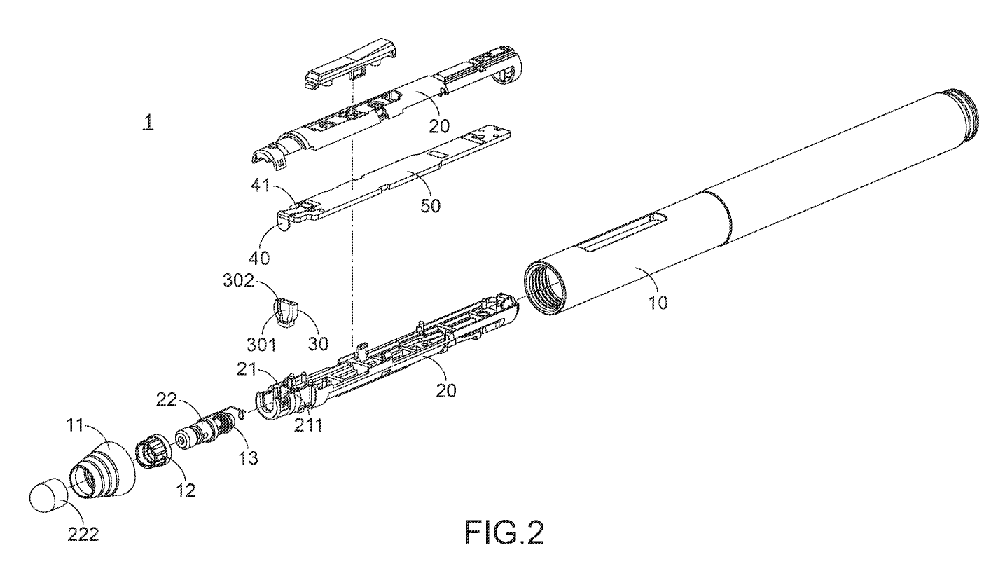

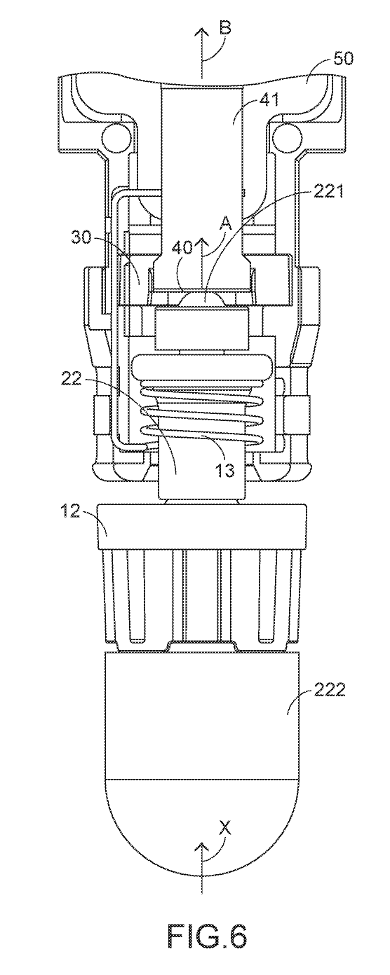

First, refer to a three-dimensional view of a preferred embodiment of the present invention in FIG. 1 and a three-dimensional exploded view of a preferred embodiment of the present invention in FIG. 2. The pressure sensitive stylus pen 1 in the present invention includes a housing 10, a housing cover 11, a stop block 12, a spring 13, a substrate 20, an accommodation slot 21, a triggering pole 22, a triggering head 222, a fastening base 30, a pressure sensor 40, and a circuit board 50. The substrate 20 is disposed inside the housing 10. The housing cover 11 is connected to the housing 10, and is used to encircle the substrate 20 in the housing 10 to prevent the substrate 20 from falling off. The accommodation slot 21 is disposed in the substrate 20 and the fastening base 30 is disposed in the accommodation slot 21. The pressure sensor 40 is fastened in the fastening base 30, so that the pressure sensor 40 is disposed in the housing 10 firmly. The circuit board 50 is disposed in the substrate 20 and is electrically connected to the pressure sensor 40. A part of the triggering pole 22 passes through the housing cover 11 ‘extends into the housing 10 and aligns the pressure sensor 40.The triggering pole 22 is movable inwardly and outwardly relative to the housing 10. The stop block 12 is disposed inside the housing cover 11 and surrounds the triggering pole 22, so that the triggering pole 22 is blocked by the housing cover 11 to prevent the triggering pole 22 from falling outside the housing 10. The spring 13 is located inside the housing 10. The spring 13 surrounds the triggering pole 22 and is connected to the substrate 20 The spring 13 elastically pushes the triggering pole 22 to move to a triggering position and restore to an original position. The triggering head 222 is connected to the triggering pole 22 and is exposed outside the housing cover 11. After the triggering head 222 is pressed by an external force X (shown in FIG. 6), the external force X is transferred to the triggering pole 22 to push the triggering pole 22 to move toward the pressure sensor 40 and to trigger the pressure sensor 40, so that the pressure sensor 40 generates a sensing signal A (shown in FIG. 6). The circuit board 50 receives the sensing signal A generated by the pressure sensor 40 (shown in FIG. 6) and generates an electronic signal B (shown in FIG. 6). The electronic signal B is transmitted to an electronic device (not shown in any figure) to input information or instructions to the device. When the triggering head 222 is not pressed by the external force X, the spring 13 pushes the triggering pole 22 to restore to an original position.

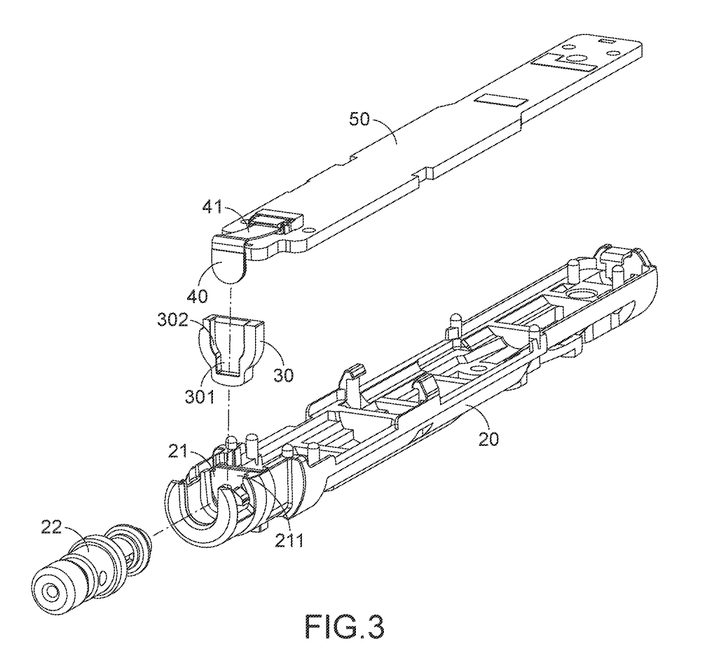

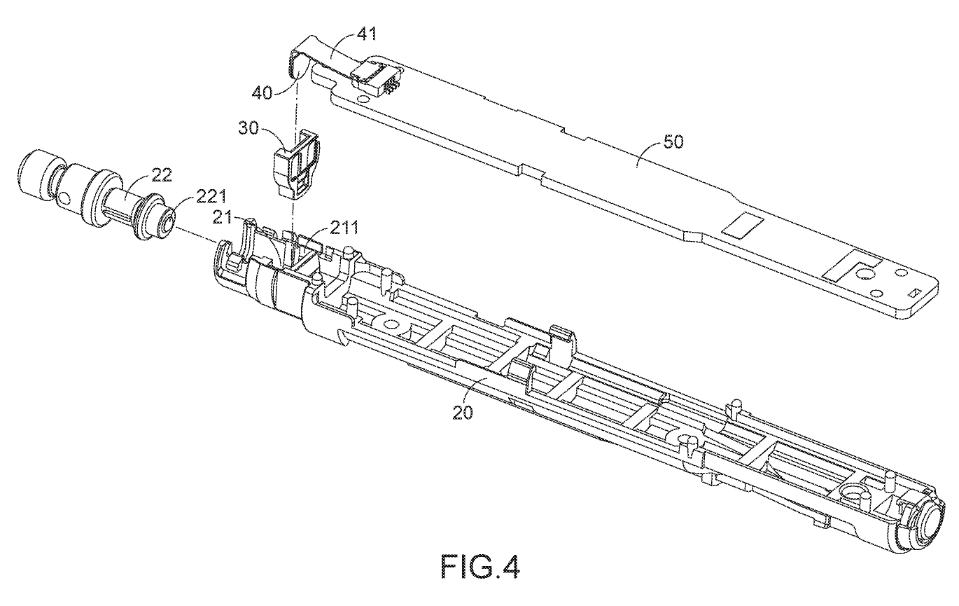

A detailed internal structure of the pressure sensitive stylus pen 1 is further described below. Refer to a three-dimensional exploded view of a substrate in a preferred embodiment of the present invention in FIG. 3 and a three-dimensional exploded view of a substrate in a preferred embodiment of the present invention in FIG. 4. The accommodation slot 21 includes an accommodating space 211. The fastening base 30 includes a concave part 302. The triggering pole 22 includes a touching end 221. The pressure sensor 40 includes a flat cable 41. The accommodation slot 21 is integrally disposed in the substrate, and the accommodating space 211 inside the accommodation slot 21 corresponds to the fastening base 30, so that the fastening base 30 is embedded into the accommodating space 211, to fasten the fastening base 30 in the substrate 20. The pressure sensor 40 is disposed in the concave part 302 of the fastening base 30. More specifically, the pressure sensor 40 is adhered to a surface 301 of the concave part 302, so that the pressure sensor 40 is fastened in the substrate 20. The touching end 221 of the triggering pole 22 and the surface 301 of the fastening base 30 are perpendicular to each other and are separated, and the touching end 221 aligns the pressure sensor 40, so that when the triggering pole 22 is moved, the touching end 221 accurately presses and triggers the pressure sensor 40. The pressure sensor 40 is connected to the circuit board 50 by using the flat cable 41When the pressure sensor 40 is pressed to generate the sensing signal A (shown in FIG. 6), the sensing signal A is transmitted to the circuit board 50, so that the circuit board 50 generates an electronic signal B (shown in FIG. 6).

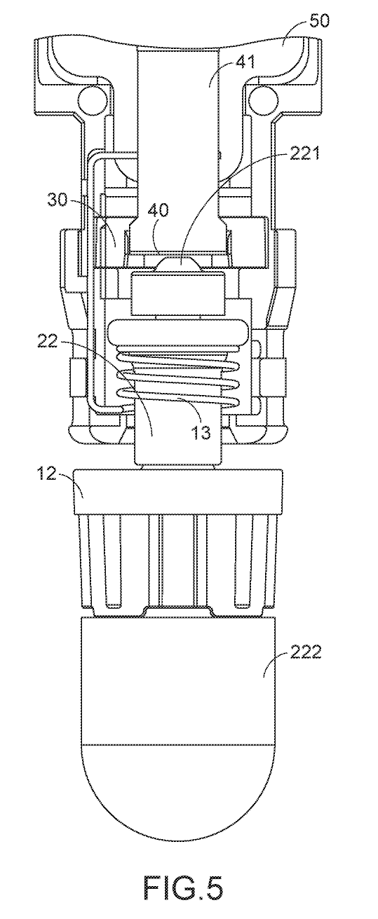

Please to refer to FIG. 5 which is a schematic diagram of a status in which a stylus pen is not touched and pressed according to a preferred embodiment of the present invention, and FIG. 6 which is a schematic diagram of a status in which a stylus pen is touched and pressed according to a preferred embodiment of the present invention. Referring to FIG. 5, when the stylus pen 1 is not pressed, the triggering head 222 bears no external force and therefore the triggering pole 22 does not move which means the touching end 221 does not press and trigger the pressure sensor 40. Referring to FIG. 6, when the stylus pen 1 is pressed, the triggering head 222 bears an external force X, and the external force X is transmitted to the triggering pole 22to push the triggering pole 22 to move toward the pressure sensor 40, so that the touching end 221 presses the pressure sensor 40to generate a sensing signal A. The sensing signal A is transferred to the circuit board 50 by the flat cable 41to generate an electronic signal B. The electronic signal B is transmitted to an electronic device to input instructions or information to the device. In addition, when the stylus pen 1 does not continue to be pressed, the external force X disappears and the spring 13 pushes the triggering pole 22 to restore to an original position which means the touching end 221 leaves the pressure sensor 40 and in this case, the pressure sensor 40 is not pressed and does not generate the sensing signal A.

In the pressure sensitive stylus pen provided in the present invention, the pressure sensor 40 is disposed in the fastening base 30 and the accommodating space 211 is disposed inside the stylus pen 1 to accommodate the fastening base 30 and the pressure sensor 40. The pressure sensor 40 can be fastened inside the stylus pen 1 so as to install the pressure sensor more easily and correctly. Besides, the pressure sensor 40 is installed firmly in the sensitive stylus pen and the problems in the prior art are resolved.

The foregoing is only preferred embodiments of the present invention, and is not intended to limit a scope of claims of the present invention; therefore, any equivalent change or embellishment made without departing from the spirit disclosed in the present invention shall fall within the scope of the present invention.

What is claimed is:

1. A pressure sensitive stylus pen, comprising:
a housing;
a substrate, disposed inside the housing;
an accommodation slot, disposed in the substrate;
a fastening base, disposed in the accommodation slot;
a pressure sensor, disposed in the fastening base, wherein the pressure sensor is configured to generate a sensing signal;
a triggering pole, wherein a part of the triggering pole extends into the housing, and when the triggering pole is touched and pressed by an external force, the triggering pole touches and presses the pressure sensor, to trigger the pressure sensor to generate the sensing signal; and
a circuit board, electrically connected to the pressure sensor, wherein the circuit board receives the sensing signal to generate an electronic signal, the pressure sensor is fastened on the fastening base, and therefore, the pressure sensor is disposed inside the housing firmly.

2. The pressure sensitive stylus pen according to claim 1, wherein the pressure sensor comprises a flat cable, used to connect the pressure sensor and the circuit board, to transmit the sensing signal to the circuit board.

3. The pressure sensitive stylus pen according to claim 1, wherein the accommodation slot comprises an accommodating space, used to embed the fastening base into the accommodation slot, to fasten the fastening base in the substrate.

4. The pressure sensitive stylus pen according to claim 1, wherein the pressure sensor is adhered to a surface of the fastening base, so that the pressure sensor is fastened in the substrate.

5. The pressure sensitive stylus pen according to claim 4, wherein the triggering pole comprises a touching end that is perpendicular to the surface of the fastening base and that is used to touch and press the pressure sensor.

6. The pressure sensitive stylus pen according to claim 1, wherein the fastening base comprises a concave part, and the pressure sensor is disposed in the concave part.

7. The pressure sensitive stylus pen according to claim 1, wherein the pressure sensitive stylus pen further comprises a housing cover and a stop block, the housing cover is connected to the housing, the stop block is disposed inside the housing cover and is located in the housing, a part of the triggering pole passes through the housing cover and extends into the housing, and the stop block surrounds the triggering pole.

8. The pressure sensitive stylus pen according to claim 1, wherein the pressure sensitive stylus pen further comprises a spring that surrounds the triggering pole.

9. The pressure sensitive stylus pen according to claim 1, wherein the accommodation slot is integrally formed in the substrate.
